(19) United States
(12) Patent Application Publication
(10) Pub. No.: US 2019/0176707 A1
(43) Pub. Date: Jun. 13, 2019

(54) FOLDABLE LADDER STRUCTURE FOR AUTOMOBILE CARGO BED

(71) Applicant: YI TING ENTERPRISE CO., LTD., New Taipei City (TW)

(72) Inventor: Ming-Te Liao, New Taipei City (TW)

(21) Appl. No.: 15/835,478

(22) Filed: Dec. 8, 2017

(51) Int. Cl. B60R 3/00

(52) U.S. Cl. CPC B60R 3/007

(57) ABSTRACT

A foldable ladder is provided for an automobile cargo bed and includes a mounting base mounted to a sideboard of the cargo bed. The mounting base has a bottom part that is pivotally coupled, by means of a first pivot joint unit, to a pivot axle, which is pivotally coupled to a pivot joint end of a frame to form a second pivot joint unit. Two side portions of the frame are respectively coupled to extension/retraction bars that are extendable outward from an operation end. Ends of the extension/retraction bars are pivotally coupled through a third pivot joint unit to ladder assembly that includes rungs. The foldable ladder positionable between the cargo bed and the ground in an expanded condition and is positioned against the sideboard of the cargo bed so as not to occupy the space of the cargo bed.

### (a) TECHNICAL FIELD OF THE INVENTION

The present invention generally relates to a foldable ladder structure, and more particularly to a foldable ladder design for mounting to an automobile cargo bed to allow a user to enter or exit the cargo bed without occupying additional space.

### (b) DESCRIPTION OF THE PRIOR ART

Automobiles are a convenient transportation. For some passenger/cargo dual-purpose automobile, such as a pickup truck, off-road performance is excellent so that it can be used as a passenger car for carrying passengers and it also has a cargo bed provided on the rear side to carry cargos, making the use thereof extremely wide and convenient. However, the structural arrangement of the body of such an automobile often present an issue that the height of the cargo bed is considered relatively high for most persons. In addition, the cargo bed also has a depth that is relatively deep and long as compared to the regular sedans. Thus, it is sometimes inconvenient in loading and unloading cargo into and from the cargo bed. Particularly, climbing up and down the cargo bed in loading and unloading cargos appears to be a challenge to physical strength and may causes physical tiredness and exhaustion of the user. One way to handle such a problem is to provide a stepping device having a proper height on the ground to ease climbing up and down the cargo bed. The stepping device, however, is a movable device and is sometimes poor in respect of stability and may get undesired movement as sliding on the ground, leading to fall of the user. In addition, such a stepping device, once placed in the cargo bed for being carried with the automobile, would occupy a certain amount of space of the cargo bed, making it imperfect in use and operation.

In view of this, the present invention aims to provide a foldable ladder structure that is directly mountable to a cargo bed of an automobile.

### SUMMARY OF THE INVENTION

The primary objective of the present invention is to provide a foldable ladder structure for an automobile cargo bed, which can be directly mounted to and collapsed to store by a sidewall of the cargo bed so as not to occupy cargo storage space of the cargo bed and also to allows efficient expansion upon use to be securely installed between the cargo bed and the ground to allow a user to step thereon for climbing and crawling in order to provide convenience and safety for the user to enter and exit the cargo bed.

To achieve the above objective, the present invention provides a foldable ladder for an automobile cargo bed, generally comprising a mounting base, a pivot axle, a frame, extension/retraction bars, and a ladder assembly, wherein the mounting base is mounted to a stop pillar of a gate board at a tail of a cargo bed the sideboard and is pivotally coupled, with a bottom thereof, to a pivot axle by means of a first pivot joint unit. The pivot axle is pivotally coupled to a pivot joint end of the frame to form a second pivot joint unit. The extension/retraction bars are respectively coupled to two side portions of the frame and are extendable outward from an operation end. Ends of the extension/retraction bars are pivotally coupled to a ladder assembly by means of a third pivot joint unit. The ladder assembly comprises at least one rung for stepping thereon.

As such, the foldable ladder of the present invention can be collapsed, by means of the pivot joint units, to normally positioned against a sideboard between the stop pillar of the gate board and a wheel arch so as not to occupy a space of the cargo bed and can be efficiently turned and extended to expand and position at the rear side of the cargo bed to make the ladder assembly stably support between the cargo bed and the ground for use.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention.

FIG. 2 is a perspective view of the present invention in an expanded condition.

FIG. 3 is a perspective view of the present invention in a folded condition.

FIG. 4 is a schematic view illustrating a state of use of the present invention as being mounted to a cargo bed in a folded condition.

FIG. 5 is a schematic view illustrating an expanding operation of the present invention.

FIG. 6 is a schematic view illustrating another expanding operation of the present invention.

FIG. 7 is a schematic view illustrating a state of use of the present invention as being mounted to the cargo bed in an expanded condition.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

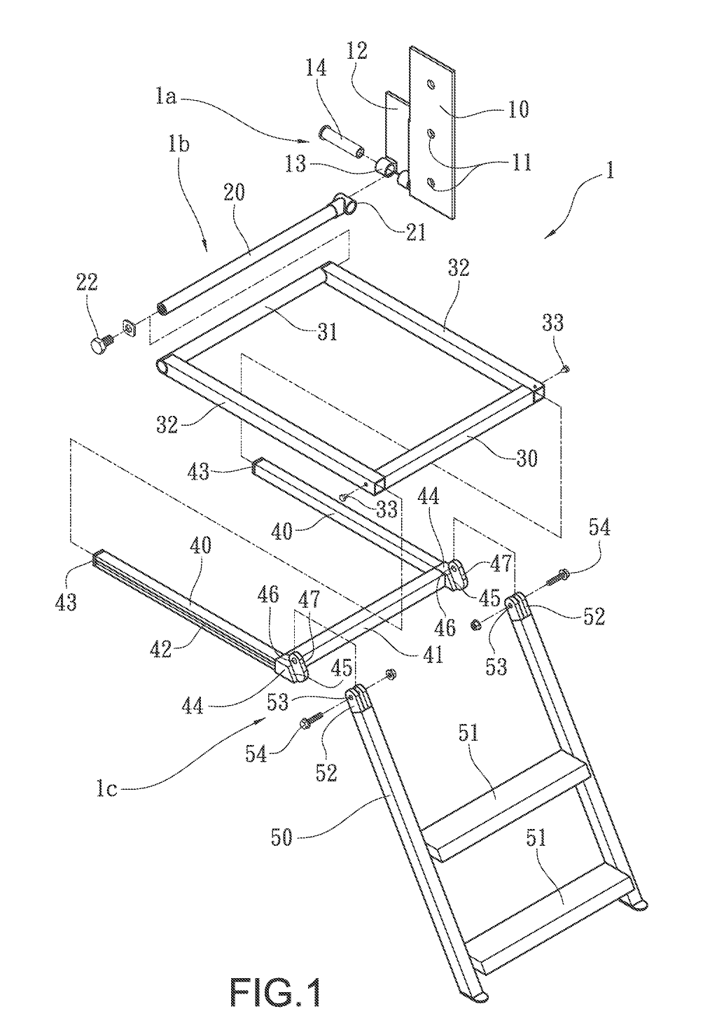

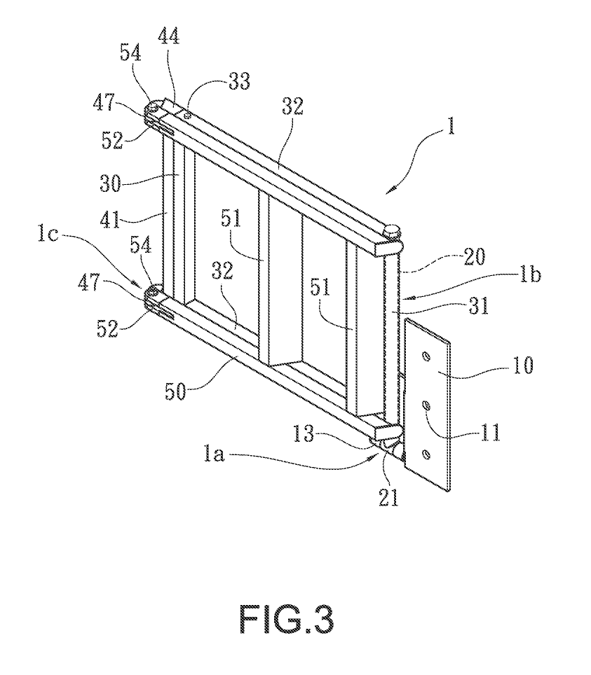

Referring to FIGS. 1-4, the present invention provides a structure of a foldable ladder 1, which generally comprises a mounting base 10, a pivot axle 20, a frame 30, extension/retraction bars 40, and a ladder assembly 50. The mounting base 10 is pivotally coupled, by means of a first pivot joint unit 1a, to the pivot axle 20, and the pivot axle 20 is pivotally coupled to a pivot joint end of the frame 30 to form a second pivot joint unit 1b. The frame 30 has two side portions that are respectively coupled to extension/retraction bars 40 that are extendable outward from an operation end thereof. The extension/retraction bars have extension ends that are pivotally coupled, by means of a third pivot joint unit 1c, to the ladder assembly 50.

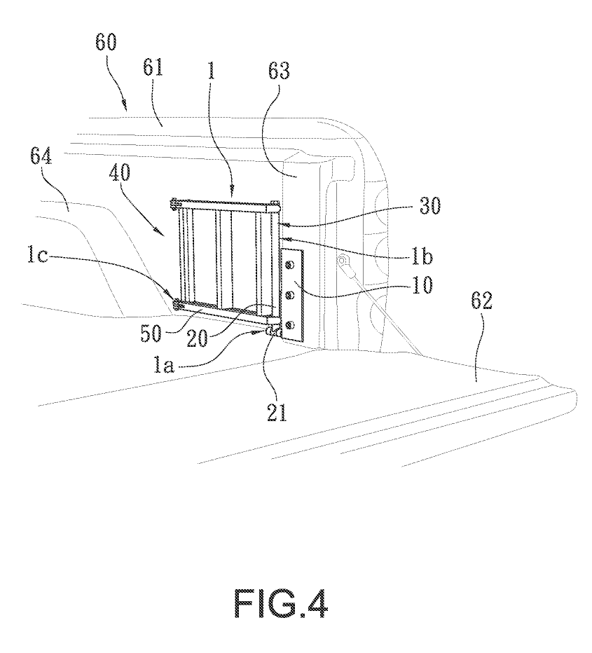

The mounting base 10 is made in a plate-like structure that is provided with a plurality of fixing holes 11 formed therein for receiving bolts for fixing to and positioning on a stop pillar 63 that is located at one side of a gate board 62 on a tail part of sideboards 61 of an automobile cargo bed 60. In the preferred embodiment shown in the drawings, the mounting base 10 further comprises an L-shaped board 12 arranged at one side of the plate thereof and bent inward for being extended in a recessed area behind the stop pillar 63. The first pivot joint unit 1a is arranged at a bottom of the L-shaped board 12 so that the foldable ladder 1 of the present invention can be installed in a manner of being completely positioned against the sideboard 61 (as shown in FIG. 4). Further, to embody the first pivot joint unit 1a, the L-shaped board 12 so extended is provided with a pivot seat 13 thereon and a pivot joint end of the pivot axle 20 is connected with a pivot sleeve 21 in a radial direction such that a pin 14 is receivable through the pivot seat 13 and the pivot sleeve 21 for pivotal coupling, allowing the pivot axle 20 to rotate in a direction toward the mounting base 10 to be positioned thereon.

The frame 30 is provided, on the pivot joint side thereof, with a tube 31 that is directly fit over and coupled to the pivot axle 20 to be fixed together by means of a fastener element 22 to form the second pivot joint unit 1b, so that the frame 30 is allowed to rotate, by means of the end of the pivot axle 20 pivotally coupled to the pivot seat 13, in directions toward front and rear sides of a body of the automobile. Further, the extension/retraction bars 40 are directly fit, at the operation side of the frame 30, into interiors of two side bar members 32 of the frame and are provided with a connection bar 41 coupled between the extension ends thereof. The side bar members 32 have outer side surfaces in each of which a recessed groove 42 is formed with a stop plate 43 mounted to a bottom end of the recessed groove 42. A side wall each of the two side bar members 32 of the frame 30 is provided, at an open end thereof, with a stop pin 33 that corresponds to the recessed groove 42 and projects inward to constrain and thus prevent the extension/retraction bars 40 from detaching from the frame 30 upon being pulled outward.

The ladder assembly 50 comprises at least one rung 51 provided between two side bars and is pivotally coupled to the extension/retraction bars 40 of the frame 30 by means of the third pivot joint unit 1c so that the ladder assembly 50 can be positioned flat on the frame 30 through rotation of the third pivot joint unit 1c. To embody the third pivot joint unit 1c, a coupling seat 44 is mounted to an external end of each of the extension/retraction bars 40 of the frame 30. The coupling seat 44 has an end face that forms a slope 45. An end of the slope 45 is provided with a protrusion plate 47 that comprises a pivot joint hole 46. The two side bars of the ladder assembly 50 are each coupled, at a pivot joint end thereof, with clamp blocks 52 that correspond to the protrusion plate 47 and the clamp blocks 52 are provided with an axle hole 53 penetrating through lateral sides thereof and corresponding to the pivot joint hole 46 for pivot coupling with a pivot joint element 54 to form the third pivot joint unit 1c.

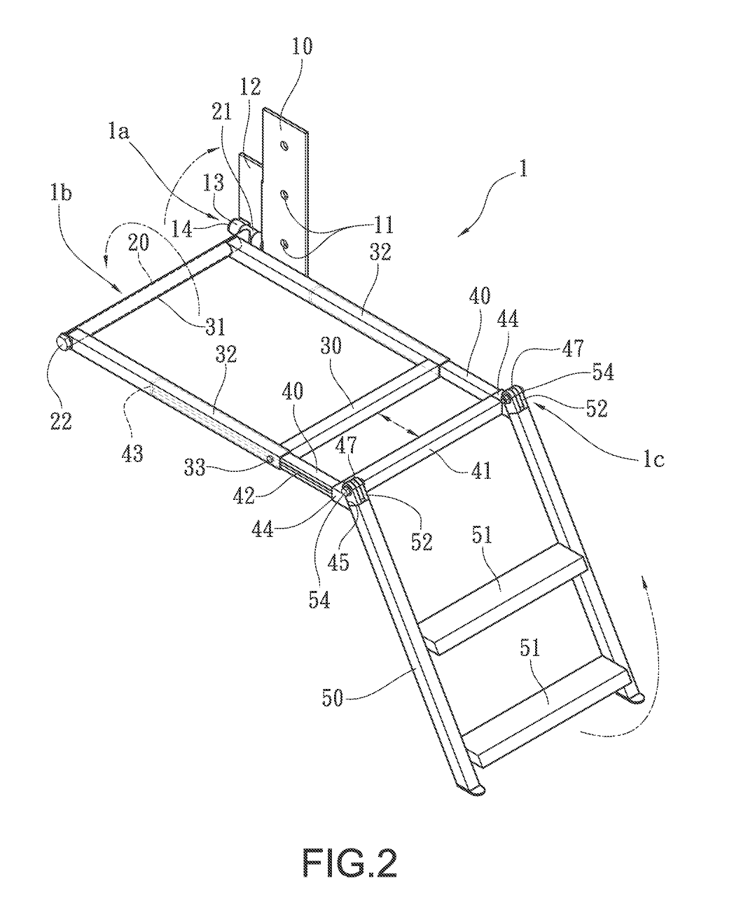

Referring to FIGS. 2-4, the foldable ladder 1 of the present invention uses the mounting base 10 to mount to the stop pillar 63 at one side of the gate board 62 of the automobile cargo bed 60. In a normal, non-use condition, the ladder assembly 50 is collapsed and laid flat on the frame 30 by means of the third pivot joint unit 1c, and meanwhile, the extension/retraction bars 40 are retracted back into the interiors of the side bar members 32 of the frame 30, and then, the frame 30, together with the ladder assembly 50, is rotated in a direction toward the front side of the automobile body through 180 degree rotation of the second pivot joint unit 1b and finally, rotated through the first pivot joint unit 1a to be erected vertically for positioning against the sideboard 61 for storage between the stop pillar 63 of the gate board 62 and a wheel arch 64. As such, in a non-used condition, the foldable ladder 1 of the present invention occupies hardly any useful operation space the cargo bed 60 and does not interference with the operation performance of the cargo bed 60.

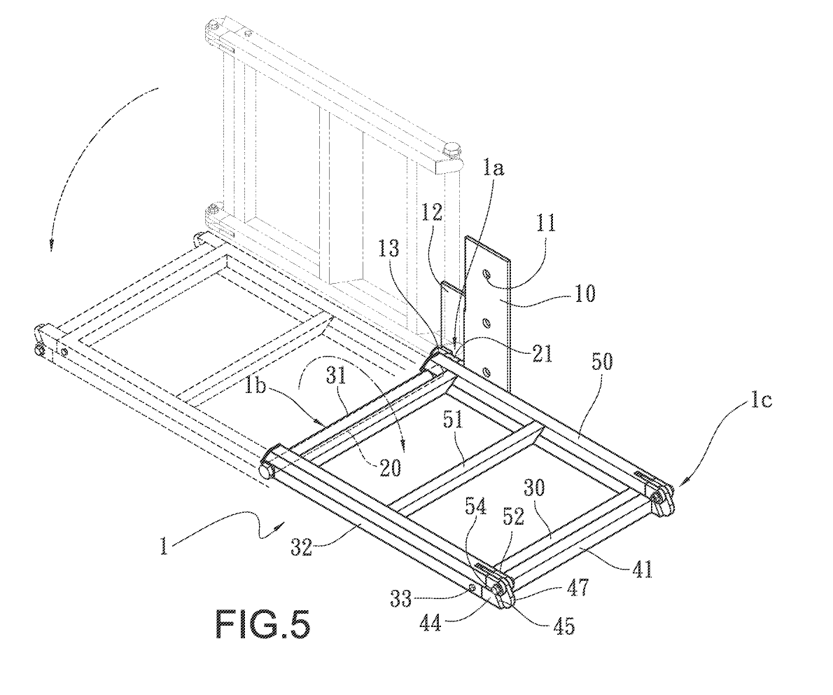

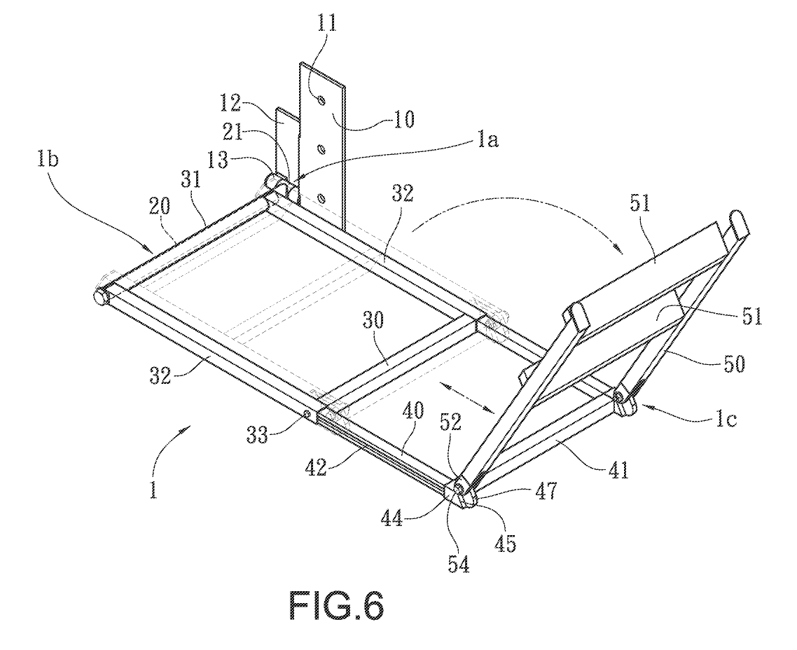

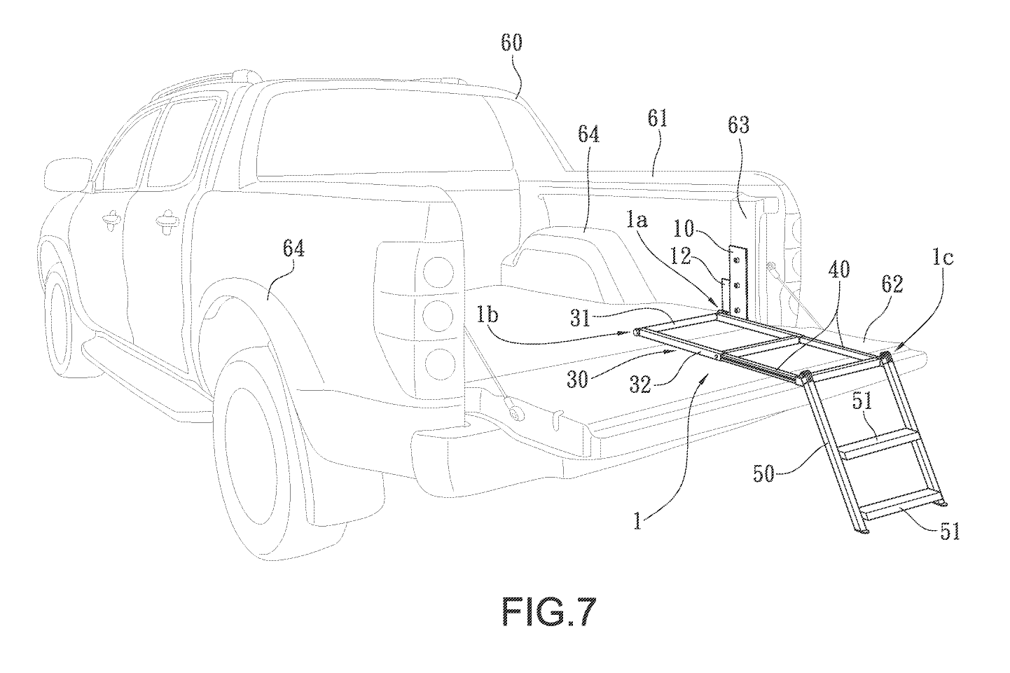

Referring to FIGS. 4-7, in an attempt to use the foldable ladder 1 of the present invention, it only needs to make a downward rotation through the first pivot joint unit 1a to be horizontally positioned and then a rotation of 180 degrees is made toward the rear side of the automobile body by means of the second pivot joint unit 1b and at the same time, the extension/retraction bars 40 of the frame 30 are pulled, together with the ladder assembly 50, in a rearward direction for extension (as shown in FIG. 5), and then the ladder assembly 50 is turned over by means of the third pivot joint unit 1c for expansion (as shown in FIG. 6) to achieve downward positioning for being supported between the gate board 62 at the tail side of the cargo bed 60 and the ground to allow a user to step on and climb or crawl in getting on or off the cargo bed 60 (as shown in FIG. 7). Further, since the third pivot joint unit 1c of the foldable ladder 1 of the present invention is provided with a structural arrangement that includes a slope 45 at an end surface of the coupling seat 44 of each of the extension/retraction bars 40, when the ladder assembly 50 is expanded and set up, sides of ends of the side bars of the ladder assembly 50 are in contact with and restrained by the slopes 45 to demonstrate a proper angle for being set between the gate board 62 and the ground. As such, it is possible to prevent the ladder assembly 50 from hitting the gate board 62 and thus causing damage of the gate board 62 resulting from excessive turning during turning or caused by climbing or crawling, and also allowing the ladder assembly 50 to be set up in an inclined manner, allowing for convenient and stable use by a user for stepping on and climbing.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A foldable ladder of an automobile cargo bed, comprising a mounting base, a pivot axle, a frame, extension/retraction bars, and a ladder assembly,
wherein the mounting base comprises a plate-like structure, which is provided with a plurality of fixing holes adapted for mounting to a stop pillar at one side of a gate board, and has a bottom that is pivotally coupled with a pivot axle by means of a first pivot joint unit;
the frame has an end that is pivotally coupled to the pivot axle in a rotatable manner so as to form a second pivot joint unit, the frame having two side portions that are respectively coupled with the extension/retraction bars that are extendable outward from an operation end thereof, and
the ladder assembly comprises at least one rung provided between two side bars, ends of the side bars being pivotally coupled, through a third pivot joint unit, to external ends of the extension/retraction bars of the frame to allow the ladder assembly to be rotated upward for collapsing to lay flat on the frame;
wherein the foldable ladder is collapsible by means of the pivot joint units to normally position against a sideboard between and a wheel arch so as to reduce an amount of space of the cargo bed occupied thereby; and in use, the ladder assembly of the foldable ladder is expandable to position between the cargo bed and the ground to allow a user to step and claim thereon.

2. The foldable ladder of the automobile cargo bed according to claim 1, wherein the mounting base comprises an L-shaped board arranged at one side thereof and bent inward, the first pivot joint unit being arranged at a bottom of the board.

3. The foldable ladder of the automobile cargo bed according to claim 1, wherein the first pivot joint unit comprises a pivot seat mounted to the plate of the mounting base and a pivot sleeve mounted to a pivot joint end of the pivot axle and extending in a radial direction, with a pin extending therethrough and pivotally coupling therebetween.

4. The foldable ladder of the automobile cargo bed according to claim 2, wherein the first pivot joint unit comprises a pivot seat mounted to the plate of the mounting base and a pivot sleeve mounted to a pivot joint end of the pivot axle and extending in a radial direction, with a pin extending therethrough and pivotally coupling therebetween.

5. The foldable ladder of the automobile cargo bed according to claim 1, wherein the extension/retraction bars of the two side portions of the frame have extension ends that are connected to each other by a connection bar and opposite ends directly fit into interiors of two side bar members of the frame, the extension/retraction bars each having an outer side surface in which a recessed groove is formed, a stop plate being mounted to an end of the recessed groove, a side wall of an open end of each of the two side bar members of the frame being provided with a stop pin that projects inward to correspond to the recessed groove.

6. The foldable ladder of the automobile cargo bed according to claim 1, wherein the second pivot joint unit comprises a tube mounted to a pivot joint side of the frame and directly fit over and coupled to the pivot axle to be fixed thereto by means of a fastener element.

7. The foldable ladder of the automobile cargo bed according to claim 4, wherein the second pivot joint unit comprises a tube mounted to a pivot joint side of the frame and directly fit over and coupled to the pivot axle to be fixed thereto by means of a fastener element.

8. The foldable ladder of the automobile cargo bed according to claim 1, wherein the third pivot joint unit comprises a coupling seat mounted to an external end of each of the extension/retraction bars of the frame, a slope being formed at an end surface of the coupling seat, the slope having an end formed with a protrusion plate that comprises a pivot joint hole formed therein, two side bars of the ladder assembly being each provided, at a pivot joint end thereof, with clamp blocks that comprises an axle hole and corresponding to the protrusion plate to be pivotally coupled thereto by means of a pivot joint element.

9. The foldable ladder of the automobile cargo bed according to claim 4, wherein the third pivot joint unit comprises a coupling seat mounted to an external end of each of the extension/retraction bars of the frame, a slope being formed at an end surface of the coupling seat, the slope having an end formed with a protrusion plate that comprises a pivot joint hole formed therein, two side bars of the ladder assembly being each provided, at a pivot joint end thereof, with clamp blocks that comprises an axle hole and corresponding to the protrusion plate to be pivotally coupled thereto by means of a pivot joint element.
